(19) United States
(12) Patent Application Publication
(10) Pub. No.: US 2005/0120223 A1
(43) Pub. Date: Jun. 2, 2005

(54) Secure authenticated network connections

(76) Inventors: Gary Kiwimagi, Greeley, CO (US); Charles McJilton, Longmont, CO (US); Craig Matthew Files, Fort Collins, CO (US)

Correspondence Address: TRENNER LAW FIRM, LLC, 12081 WEST ALAMEDA PARKWAY #163, LAKEWOOD, CO, 80228, US

(21) Appl. No.: 10/890,877

(22) Filed: Jul. 14, 2004

Related U.S. Application Data
(63) Continuation-in-part of application No. 10/726,231, filed on Dec. 1, 2003.
(63) Continuation-in-part of application No. 10/780,974, filed on Feb. 17, 2004.

(51) Int. Cl. H04K 1/00

(52) U.S. Cl. 713/182

(57) ABSTRACT

Implementations described and claimed herein provide access, e.g., to building automation systems, via a secure authenticated network: connection. A secure authenticated network connection may be established in a network environment according to one implementation between a client and a system node (e.g., a server controlling the building automation system). The system node registers with a data node and the control node maintains a listing of clients authorized to access the system node. When a client desires access to the system node, the client requests access via the control node. The control node authenticates the client as an authorized user and establishes a secure authenticated connection between the client and the system node via the data node.

### PRIORITY CLAIM

This application is a continuation-in-part of co-owned U.S. patent application Ser. No. 10/726,231 for “Secure Network Connections” of Kiwimagi, et al. (Attorney Docket No. CVN.015.USP), filed Dec. 1, 2003, and co-owned U.S. patent application Ser. No. 10/780,974 for “Secure Authenticated Network Connections” of Kiwimagi, et al. (Attorney Docket No. CVN.015.CIP1), filed Feb. 17, 2004, each hereby incorporated herein for all that it discloses.

### TECHNICAL FIELD

The described Subject matter relates to networks for electronic computing, and more particularly to systems and methods of establishing secure authenticated network connections for electronic computing systems.

### BACKGROUND

The ability to automatically control one or more functions in a building (e.g., lighting, heating, air conditioning, security systems) is known as building automation. Building automation systems may be used, for example, to automatically operate various lighting schemes in a house. Of course building automation systems may be used to control any of a wide variety of other functions, more or less elaborate than controlling lighting schemes.

It is often desirable to remotely access the building automation system to monitor and/or change various functions of the building automation system. For example, a homeowner planning to return home from a vacation earlier than initially expected may want to change the building automation system from a vacation mode to an “every-day” mode prior to the occupants returning home. In another example, an integrator may be responsible for installing and/or maintaining automation systems for a number of customers and may want to remotely access a customer's automation system to assist the customer. These examples are merely illustrations of two types of remote access that may be desired as there are others too numerous to discuss.

Building automation systems may be remotely accessed via networks such as the Internet or telephone networks. However, providing remote access over a public communication network also makes the building automation system vulnerable to unauthorized access, e.g., by hackers. It is therefore desirable to provide remote access via a secure authenticated connection.

### SUMMARY

Implementations described and claimed herein provide access, e.g., to building automation systems among other electronic computer systems, via a secure authenticated network connection. A secure a authenticated network connection may be established in a network environment according to one implementation between a client and a system node (e.g., a server controlling the building automation system).

In some implementations, articles of manufacture are provided as computer program products. One implementation of a computer program product provides a computer program storage medium readable by a computer system and encoding a computer program for establishing a secure authenticated connection. Another implementation of a computer program product may be provided in a computer data signal embodied in a carrier wave by a computing system and encoding the computer program to establish a secure authenticated network connection.

The computer program product encodes a computer program for executing on a computer system a computer process that registers a plurality of system nodes with the data node, identifying at the control node a number of clients authorized to access the system nodes, receives at the control node a request from an authorized client to access and control at least one of the system nodes, and establishes via the control node and data node a secure authenticated connection between the authorized client and the system node.

In another exemplary implementation, a method is provided. The method may be implemented to register a plurality of system nodes with a data node communicatively coupled to a control node, identify at the control node a number of clients authorized to access each of the system nodes, receive at the control node a request from an authorized client to access and control at least one of the system nodes, and establish via the control node and data node a secure authenticated connection between the authorized client and the system node.

In yet another exemplary implementation a service provider system is provided for establishing a secure authenticated network connection between remote clients and system nodes for controlling building automation systems. An exemplary service provider system may include a data node securely connecting to a plurality system nodes, the data node registering each of the securely connected system nodes, and a control node communicatively coupled to the data node. The control node authenticates a remote client to access and control at least one of the system nodes registered with the data node and then establishes a secure authenticated connection between the remote client and the system node.

### BRIEF DESCRIPTION OF THE DRAWINGS

FIG. 1 is a schematic illustration of an exemplary network for establishing a secure authenticated connection;

FIG. 2 is a schematic illustration showing an exemplary implementation of electronic computing systems that can be used to establish a secure authenticated connection over a network;

FIGS. 3(a) through (f) illustrate exemplary operations to establish a secure authenticated connection over a network;

FIG. 4 illustrates an alternative exemplary implementation to establish a secure authenticated connection over a network;

FIG. 5 is a flow diagram illustrating alternative exemplary operations to establish a secure authenticated connection over a network; and

FIG. 6 is a schematic illustration of an exemplary computing device that can be utilized to establish a secure authenticated network connection.

### DETAILED DESCRIPTION

A user may desire to connect to a building automation system to access various automation functions (e.g., lighting, security, and climate controls) for the building. Configuration/monitoring software (e.g., a web-enabled application) may be provided via a server computer so that the user can use any available computer with a network connection. Alternatively, the integrator's laptop may have the configuration/monitoring software installed.

In one example, a homeowner may visit an Internet café while on vacation and access his or her home automation system to monitor security or adjust the thermostat prior to returning home. In another example, an integrator may use a desktop or laptop computer to access a customer's automation system to assist the customer with an automation function (e.g., to change a lighting or climate control scheme). Of course remote access to the building automation system may be desired for any of a wide variety of other reasons as well.

Access to the building automation system is preferably established via a secure authenticated network connection. Briefly, a secure authenticated network connection may be established in a network environment between a client, such as the integrator's laptop PC, and a system node provided with the building automation system.

Although exemplary implementations are described herein with reference to building automation systems, it should be understood that the scope is not limited to use with building automation systems and the invention may also find application in a number of different types of electronic computing systems now known or later developed.

Exemplary Architecture

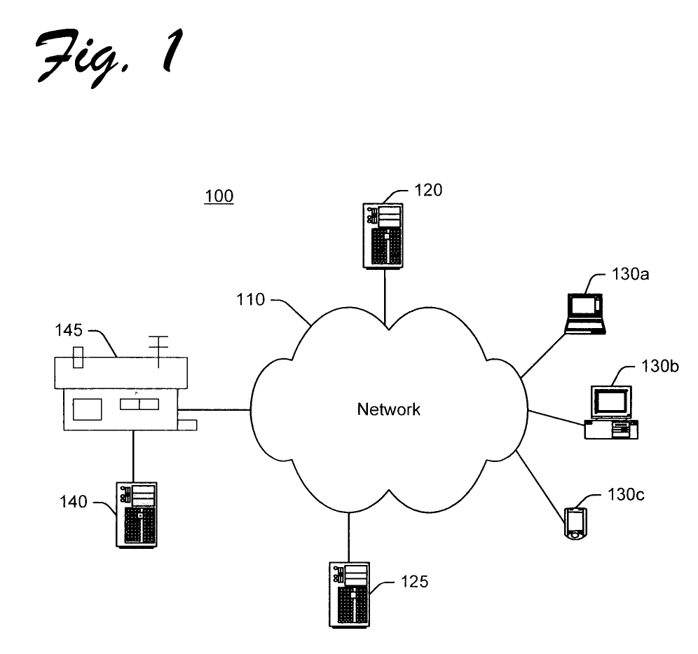

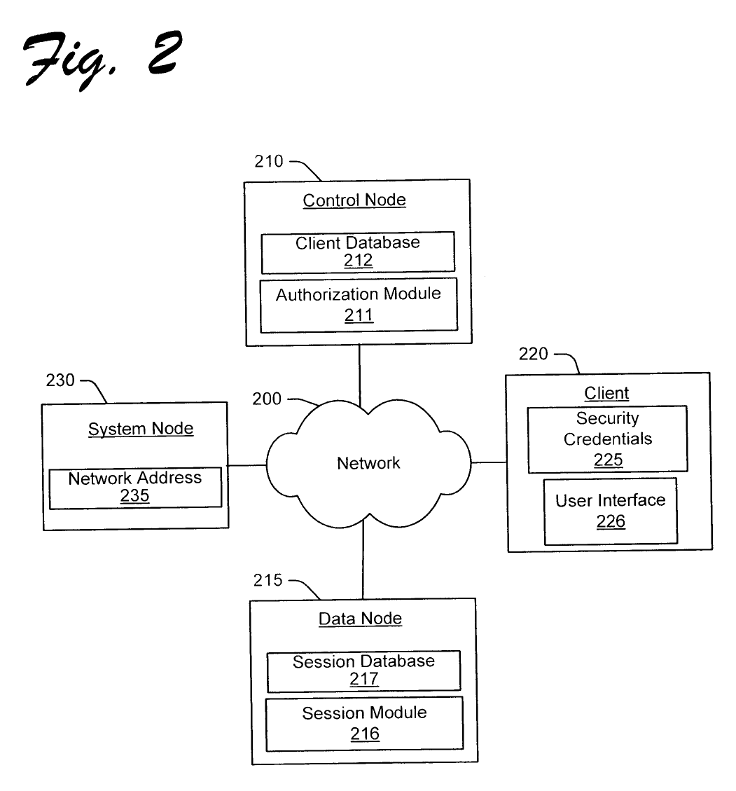

FIG. 1 is a schematic illustration of an exemplary networked computing system 100 in which a secure authenticated network connection may be established according to one implementation. The networked computer system 100 may include one or more communication networks 110, such as a local area network (LAN) and/or wide area network (WAN). A control node 120 and data node 125 may be provided to facilitate a secure authenticated connection between one or more clients 130a, 130b, 130c (hereinafter, generally referred to as 130) and a system node 140 (e.g., a server computer implemented in a building automation system at building 145).

As used herein, the term “node” is used to refer to hardware and software (entire computer system) used to perform various network services. A node may include one or more computing systems, such as a server, that also runs other applications or that is dedicated only to server applications. A node connects to a network via a communication connection, such as a dial-up, cable, or DSL connection via an Internet service provider (ISP).

A node may provide services to other computing or data processing systems or devices. For example, system node 140 may be implemented as a server computer to start processes in a building automation system. System node 140 may also provide other services, such as Internet and email services. Control node 120 and data node 125 may also be implemented as one or more server computers to broker security and optionally provide application software to the client, as will be discussed in more detail below.

As used herein, the term “client” refers to the hardware and software (the entire computer system) used to perform various computing services. A client may include a computing system(s), such as a stand-alone personal desktop or laptop computer (PC), workstation, personal digital assistant (PDA), or appliance, to name only a few. A client also connects to a network via a communication connection, such as a dial-up, cable, or DSL connection via an Internet service provider (ISP) or may connect directly into a LAN, e.g., for the building automation system via network connection.

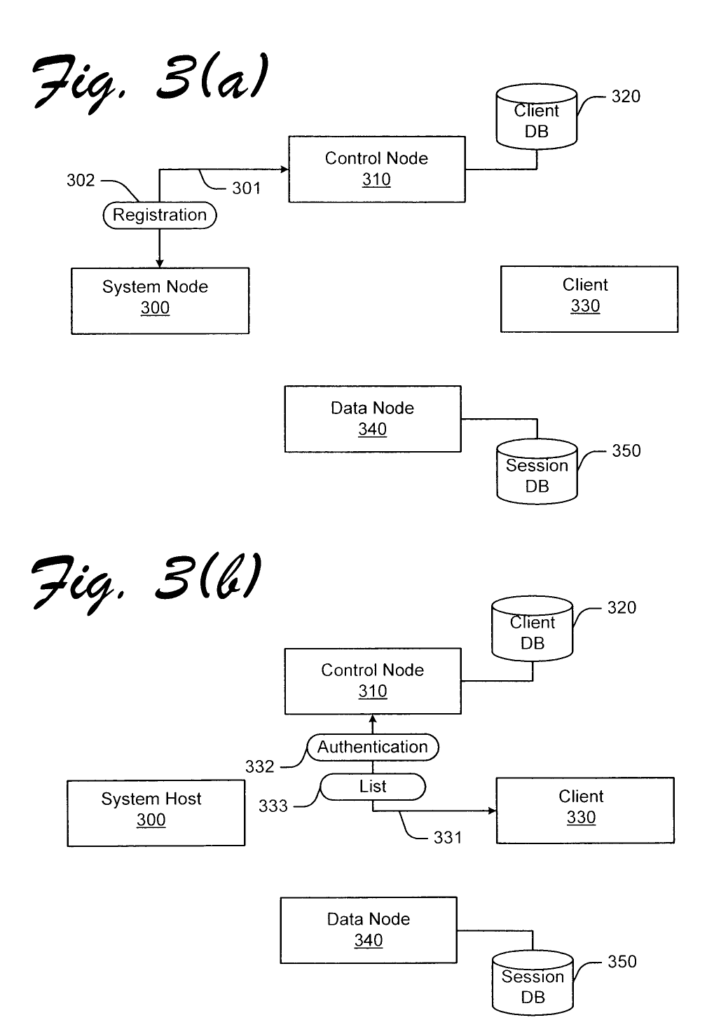

FIG. 2 is a schematic illustration showing an exemplary implementation of computer systems that can be connected on a network 200. According to this implementation, a control node 210 and a data node 215 may cooperate to establish a secure authenticated connection (e.g., via network 200) between a client 220 and a system node 230.

System node 230 may be implemented, e.g., as a server computer operating a building automation system. System node 230 may include application software (not shown). For example, application software may be provided to monitor the status of the building automation system, and administer various automation functions. System node may also serve as a central repository for program code that controls the various building automation devices. Client 220 may access system node 230 to control, configure, and/or monitor the system node 230 (e.g., building automation system).

System node 230 is identified on the network by a network address 235. The network address may be any address that identifies a system node 230 on a network 200. By way of example, the network address may include an Internet Protocol (IP) address, although higher level addresses (e.g., a domain name) may also be used in other implementations. System node 230 provides its network address 235 to the control node 210 during a registration operation so that the system node 230 can be identified on the network, e.g., by the client 220.

The network address may be a dynamic (i.e., changing) network address. Use of a dynamic network address adds another layer of security to the network connection because a client 220 cannot simply store the network address and reuse it at a later time to regain access to the system node 230. Instead, the dynamic network address is updated at the control node 210 and the client 220 has to request the current network address from the control node 210 before the client 220 is able to access the system node 230.

Client 220 may be implemented in a laptop or desktop computer, or in any other suitable device which is capable of establishing a network connection, and sending and/or receiving data over that network connection (e.g., a PDA or mobile phone). Client 220 may include security credentials 225 (e.g., UserID and password) that may be presented to the control node 210 and/or the data node 215 to authenticate the client 220 for access to the system node 230.

Client 220 may also include a user interface module 226. User interface module 226 may be implemented as program code (e.g., software). User interface module 226 may be used, for example, by a homeowner, integrator, or other user to send and receive messages or process transactions.

Client 220 may request access to the system node 230 (i.e., a client session) by control node 210. In an exemplary implementation, control node 210 includes an authorization module 211. Authorization module 211 may be implemented as computer readable program code (e.g., software, firmware) stored in computer readable storage or memory and executable by a processor (or processing units) operatively associated with the control node 210. Authorization module 211 performs operations, such as authorizing the client (e.g., based on security credentials 225) and generating session information in response to a request by a client 220 to access a system node.

Session information may include data in any suitable format to identify a client session to the data node 215. In an exemplary implementation, session information includes the network address(es) for a requested system node 230 and the identity of the client 220 authorized to access the system node 230. Session information also includes one or more conditions that the client 220 must satisfy before being authenticated by the data node 215. For purposes of illustration, the client 220 may be required to present a valid UserID and password, although other implementations are also contemplated as being within the scope of the invention (e.g., the use of security certificates or security keys).

Session information may also include other information about the client session. By way of example, session information may also include an expiration time for the client session. Upon expiration, the client 220 may no longer be able to access the system node 230 without being re-authenticated by the control node 210. As another example, session information may identify client permissions (e.g., functions that the client 220 is authorized to access at the system host 230). Still other implementations are also contemplated, as will be readily apparent to those skilled in the art after having become familiar with the teachings of the present invention.

Authorization module 211 may also register system nodes 230 at the control node 210. During a registration operation, the system node(s) 230 provide their network address to the control node 210. Control node 210 maintains the network address in a client database 212. In an implementation using dynamic network addresses, client database 212 is updated in response to a different network address being assigned to the system node 230, or on some other recurring or periodic basis (e.g., every 4 hours).

Control node 210 may be communicatively coupled to the data node 215 (e.g., via network 200 or other suitable connection). In an exemplary implementation, data node 215 includes a session module 216 which cooperates with control node 210 to establish a connection between the client 220 and the system node 230. Session module 216 may also be implemented as computer readable program code (e.g., software, firmware) stored in computer readable storage or memory and executable by a processor (or processing units) operatively associated with the data node 215.

Session module 216 is operatively associated with a session database 217. Session module 216 populates session database 217 with session information received from the control node 210 for a client session. When the client 220 requests access to the system node 230, data node 215 uses the session information in session database 217 to establish a secure authenticated connection between the client 220 and the system node 230.

Exemplary Operations

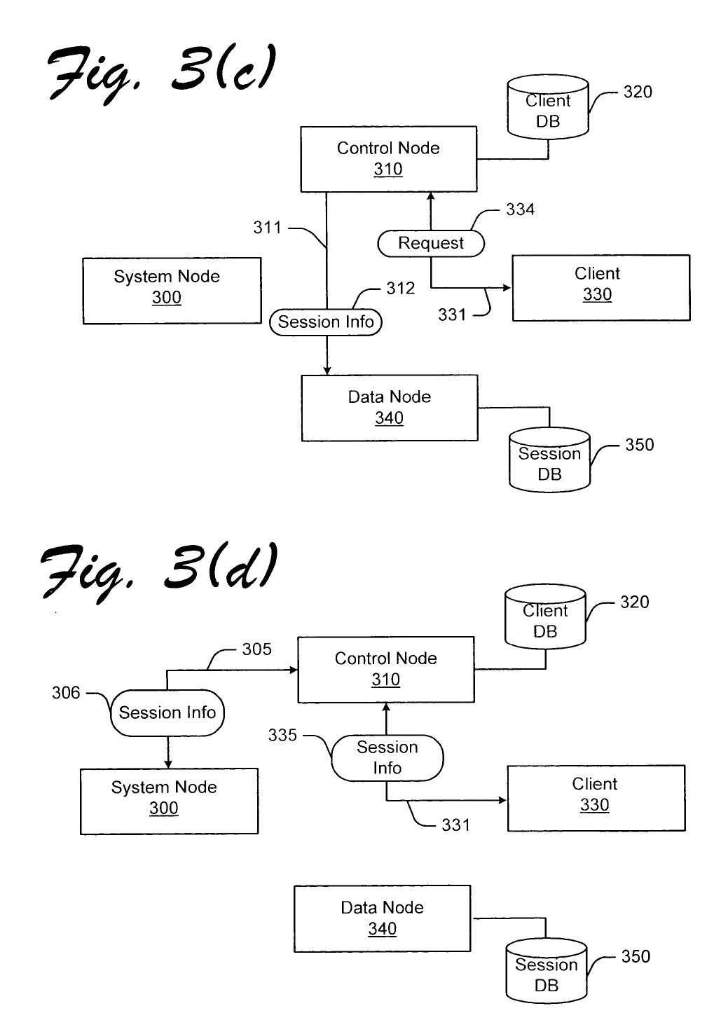

FIGS. 3a through 3f illustrate exemplary methods for implementing remote access to a system node (e.g., for a building automation system) via a secure authenticated network connection. The methods described herein may be embodied as logic instructions. When executed on a processor (or processing devices), the logic instructions cause a general purpose computing device to be programmed as a special-purpose machine that implements the described methods. In the following exemplary operations, the components and connections depicted in the figures may be used to implement a secure authenticated network connection.

In FIG. 3a, one or more system nodes 300 register with at control node 310 via a suitable communications link 301 (e.g., TCP/IP). The control node 310 authenticates each system node 300, e.g., based on information about the system node. Registration information 302 (e.g., data node and corresponding network address) for each registered system node 300 may also be maintained in the client database 320. Other information, such as the status of a system node 300 may also be maintained in the client database 320 (e.g., online, busy).

In FIG. 3b, client 330 initiates a client session with the system node 300 by establishing a communications link 331 with the control node 310 (e.g., via HTTPS at a secure web site). The client provides authentication information 332 (e.g., UserID and password) to the control node 310. The control node 310 authenticates the client 330, e.g., based on information maintained in client database 320, and returns a data structure (e.g., list 333) identifying registered system nodes 300 that the client 330 has permission to access. The list 333 may also indicate whether the system node 300 is registered (e.g., whether the dynamic address has been updated) and the status of the system node 300.

Before continuing, it should be noted that control node 310 resides at a “known” network address (e.g., a static IP address). Accordingly, the control node 310 may be readily accessed by the system node(s) 300 (e.g., during registration) and by the client(s) 330.

In FIG. 3c, the client 330 sends a request 334 to the control node 310 identifying a registered system node from the list 333. The control node 310 verifies that the client 330 satisfies the access permissions for the requested system node 300 (e.g., based on information maintained in client database 320), and that the system node 300 is registered and available.

If the client 330 has access permissions to the requested system node 300, and the requested system node 300 is registered and available, the control node 310 generates session information 312. The control node 310 sends the session information 312 to data node 340 over communications link 311 (e.g., via a secure socket connection where it is stored in session database 350). In an exemplary implementation, the control node 310 and data node 340 may be located physically close to one another and a secure connection may be established behind a local firewall. Optionally, the control node 310 may be authenticated by the data node 340.

In FIG. 3d, a secure communications link (e.g., HTTPS) 305 is established between the control node 310 and the system node 300. The control node 310 then provides session information 306 to the system node 300. The session information 306 provided to the system node 300 may include a TCP/IP address/port/security key, and session ID for establishing connections with the data node 340.

The control node 310 also provides session information 335 to the client 330. The session information 335 provided to the client 330 may also include TCP/IP address/port/security key, and session ID for establishing a connection with the data node 340.

In FIG. 3e, the system node 300 establishes a secure communications link 341 with the data node 340 (e.g., HTTPs) and gives the data node 340 a request for a session 342. The client 330 establishes a secure communications link 360 with the data node 340 (e.g., via a secure socket connection), and sends a request 345 for a client session with the system node 300. The data node 340 authenticates the request 345, for example, based on the session information 312 received in FIG. 3c. The client 330 is then linked to the system node 300 over a secure authenticated connection via the data node, as illustrated below with reference to FIG. 3f.

In an exemplary implementation illustrated in FIG. 3f, the client 330 may request data from the system node 300 via secure authenticated connection 360 to the data node 340. The data node 340 in turn notifies the system node 300 of the client request (e.g., via a non-secure socket 361). The system node 300 establishes a secure (optionally temporary) connection 362 with the data node 340 and returns the requested data to the data node 340 over connection 362. Data node 340 in turn returns the requested data to the client 330 over secure authenticated connection 360.

In another exemplary implementation also illustrated in FIG. 3f, the client 330 may submit a message with a command for the system node 300 via secure authenticated connection 360 to the data node 340. The data node 340 notifies the system node 300 that the message is pending (e.g., via a non-secure socket 361). The system node 300 establishes a secure (optionally temporary) connection 362 with the data node 340 and retrieves the message from the data node 340 via connection 362. System node 300 may then execute the command.

In another exemplary implementation also illustrated in FIG. 3f, the client 330 may submit a message with configuration data for the system node 300 via secure authenticated connection 360 to the data node 340. The data node 340 notifies the system node 300 that the message is pending (e.g., via a non-secure socket 361). The system node 300 establishes a secure (optionally temporary) connection 362 with the data node 340 and retrieves the message from data node 340 via connection 362. The system node 300 may then apply the configuration data to the building automation system.

In another exemplary implementation, again illustrated in FIG. 3f, the client 330 may terminate the client session with the system node 300. The client 330 notifies the data node 340 to terminate the session via secure authenticated connection 360. The data node 340 closes all communications links (e.g., secure optionally temporary link 362 and non-secure link 361) with the system node 300. Optionally the data node 340 removes the session information for the terminated session from the session database 350.

It is noted that the connections 360, 361, and 362 may be established and reestablished, or may be maintained throughout a common client session. It is also noted that the system node 300 may send status messages 370 to the control node 310 indicating its status (e.g., available, busy).

Alternative Implementation

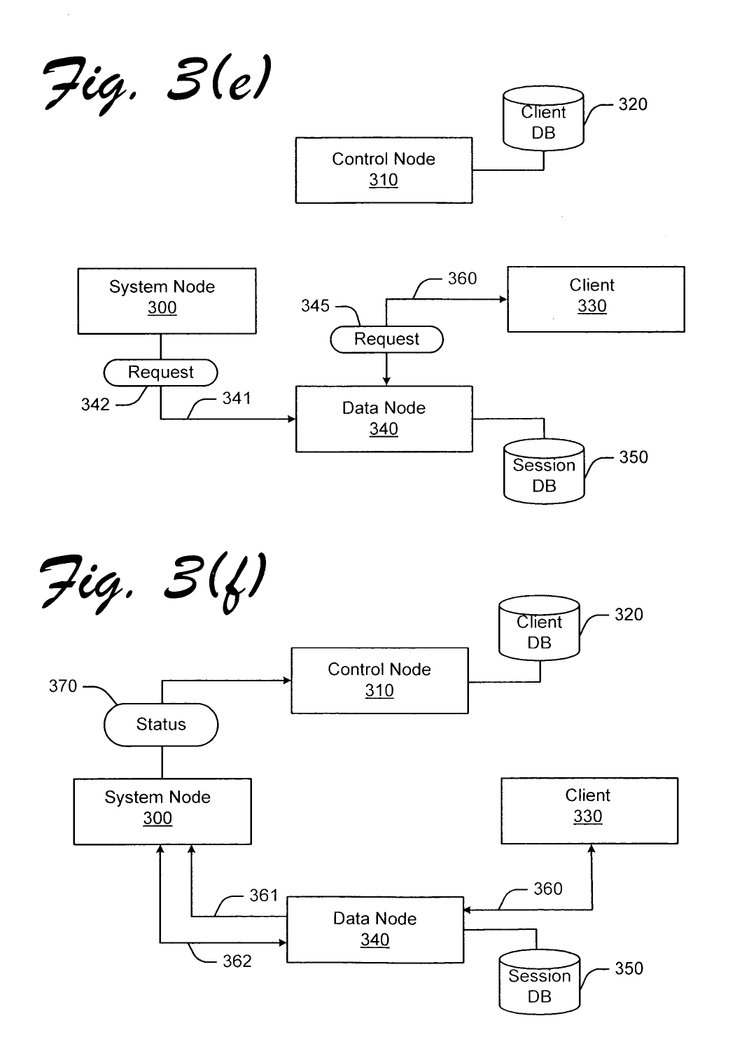

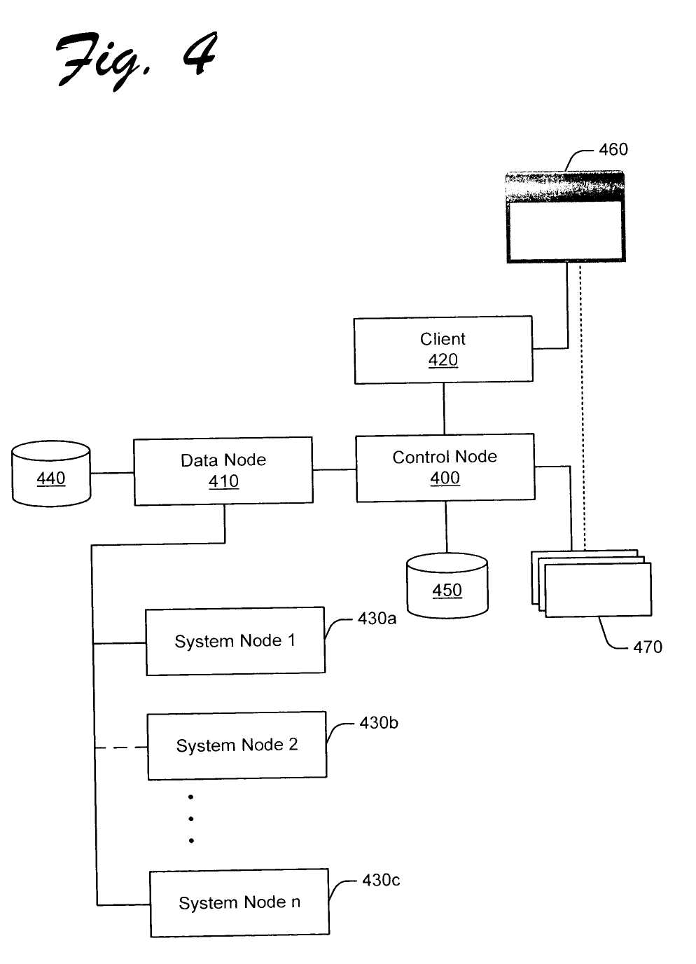

FIG. 4 illustrates alternative exemplary implementations to establish a secure authenticated connection over a network. According to this implementation, a control node 400 and a data node 410 may cooperate to establish a secure authenticated connection (e.g., via a network connection) between a client 420 and one or more system nodes 430a-c (generally referred to as system node 430) so that authorized clients may control the system nodes remotely.

Such an arrangement of data node/control node provides a security buffer between the clients 420 and the system node 430. That is, the clients 420 do not directly access the system nodes 430. Nor do the clients 420 access the data node 410 which is connected to the system nodes. Instead, the clients 420 must first be authenticated by the control node 400 before being permitted access via a secure connection through the control node 400 and data node 410.

In an exemplary implementation, system nodes 430 may be servers or bridges for building automation systems, and the data node 410 and control node 400 may be server computers at a service provider headquarters. System node 430 is identified to the data node 410 by a network address, such as, e.g., an Internet Protocol (IP) address. System nodes 430 may provide their network address to the data node 410 during a registration operation. The data node 410 may store the network address, e.g., in data store 440.

Data node 410 may also track the status of the system nodes 430 (e.g., “online/offline”) and store this information and/or other information related to the system nodes 430 in data store 440. In an exemplary implementation, the system nodes 430 are always connected to the data node 410 via a secure connection except during maintenance/upgrades or other reasons which are typically temporary in nature (e.g., during a system reset or power failure).

Control node 400 may be implemented as a web server communicatively coupled to the data node 410. Control node 400 maintains a cross-reference table (e.g., in data store 450) identifying clients 420 authorized to access the system node(s) 430. Clients 420 access the system node 430 via the control node 400 which controls access to the system nodes 430 and allows authorized users to control the system node 430.

Accordingly, clients 420 may access the system nodes 430 via control node 400 without having to establish a direct connection to the system nodes 430. In addition, the control node 400 may be configured to specify restricted access to the system node 430. For example, a client may only have monitoring permissions and be denied access to modify system settings for a building automation system associated with a system node 430. Or for example, a client may only have access to particular functions in a building automation system.

In operation, a user desiring access to a system node 430 may establish a network connection between the client 420 and the control node 400. The user provides user credentials (e.g., a login and password) to the control node 400. The control node 400 determines the user's access permissions, e.g., based on the cross-reference table in data store 450, and returns a web page 460 listing the system nodes 430 that the user is authorized to access. The web page 460 may also include other information, such as, e.g., the online status of the system node(s) 430.

Control node 400 may generate data 470 identifying system nodes 430. The user may select a system node 430 from the generated data 470, e.g., when displayed on web page 460. In response, the control node 400 sends a message to the data node 410 requesting access to the selected system node 430. The data node 410 sends the request to the system node 430 and forwards to a predetermined port (e.g., port 80) on the system node via an SSH tunnel between the system node and the data node.

SSH is a protocol that allows an encrypted network connection (or “tunnel”) to be established between a first server (e.g., system node 430) and a second server (e.g., data node 410). More specifically, the second server accepts connections for designated ports on a local machine (e.g., the system nodes 430). Data which is sent to these designated ports is then forwarded and returned through the tunnel.

Accordingly, clients 420 are able to access the system node 430 via control node 400 and all transactions with the client 420 are automatically and securely routed by the control node 400 to the desired system node 430.

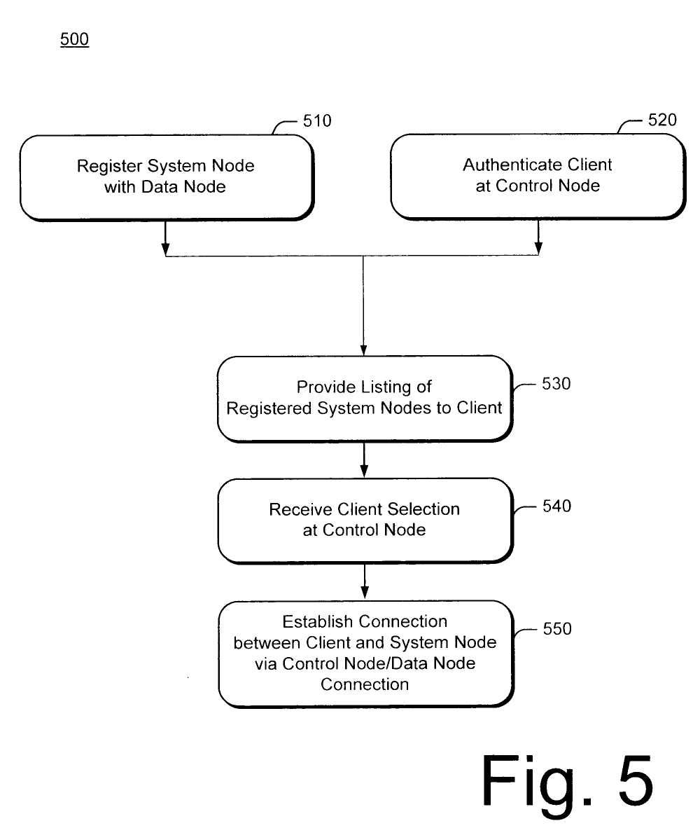

FIG. 5 is a flow diagram illustrating exemplary operations 500 to establish a secure authenticated connection over a network. In operation 510 a system node may be registered with a data node. As discussed above, the data node may maintain a listing of each system node and its status (e.g., online/offline).

When a user desires access to the system node, the user requests access via the control node. In operation 520, the client is authenticated at the control node. In operation 530, the control node provides a listing of registered system nodes to the client. The user may select one of the registered system nodes that the user is authorized to access. In operation 540 the user's selection is received by the control node. In operation 550, the control node established a connection between the client and system node via the control node/host node connection.

It is noted that the operations are not limited to any particular order. For example, operations 510 may occur synchronously with operation 520, as illustrated in FIG. 5, or one of the operations may occur asynchronously with the other.

Exemplary Computing Device

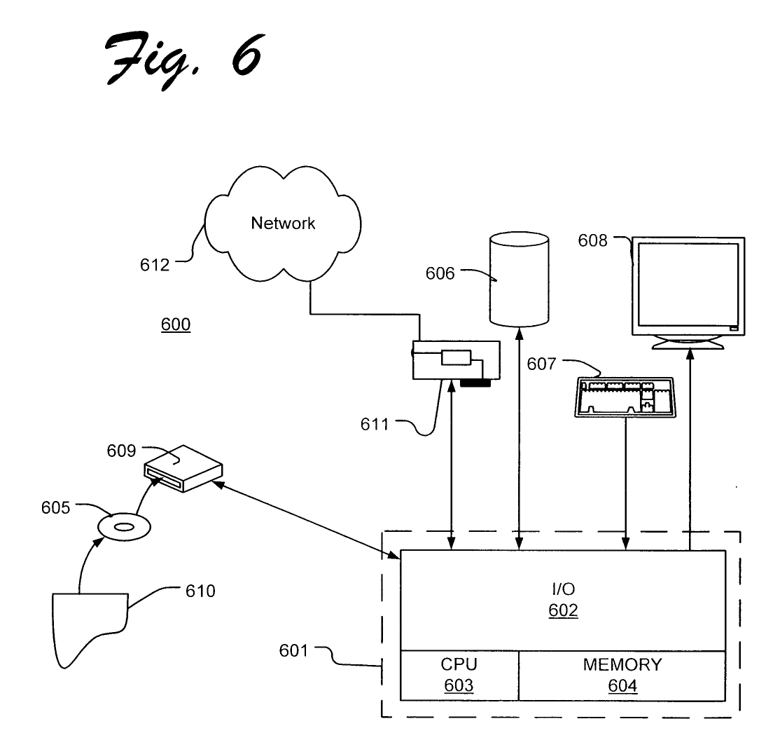

FIG. 6 depicts an exemplary general purpose computer 600 capable of executing a program product and establishing a secure authenticated network connection. In such a system, data and program files may be input to the computer, including without limitation by removable or non-removable storage media or a data signal propagated on a carrier wave (e.g., data packets over a network). The computer 600 may be a conventional computer, a distributed computer, or any other type of computing device.

The computer 600 can read data and program files, and execute the programs and access the data stored in the files. Some of the elements of an exemplary general purpose computer are shown in FIG. 6, including a processor 601 having an input/output (I/O) section 602, at least one processing unit 603 (e.g., a microprocessor or microcontroller), and a memory section 604. The memory section 604 may also be refereed to as simply memory, and may include without limitation read only memory (ROM) and random access memory (RAM).

A basic input/output system (BIOS), containing the basic routines that help to transfer information between elements within the computer 600, Such as during start-up, may be stored in memory 604. The described computer program product may optionally be implemented in software modules loaded in memory 604 and/or stored on a configured CD-ROM 605 or other storage unit 606, thereby transforming the computer system in FIG. 6 to a special purpose machine for implementing the described system.

The I/O section 602 is optionally connected to keyboard 607, display unit 608, disk storage unit 606, and disk drive unit 609, typically by means of a system or peripheral bus (not shown), although it is not limited to these devices. The system bus may be any of several types of bus structures including a memory bus or memory controller, a peripheral bus, and a local bus using any of a variety of bus architectures.

Typically the disk drive unit 609 is a CD-ROM drive unit capable of reading the CD-ROM medium 605, which typically contains programs 610 and data. Computer program products containing mechanisms to effectuate the systems and methods in accordance with the present invention may reside in the memory section 604, on a disk storage unit 606, or on the CD-ROM medium 605 of such a system. Alternatively, disk drive unit 609 may be replaced or supplemented by a floppy drive unit, a tape drive unit, or other storage medium drive unit. The network adapter 611 is capable of connecting the computer system to a network 612. In accordance with the present invention, software instructions directed toward accepting and relaying access information (e.g., authentication and security data) may be executed by CPU 603, and databases may be stored on disk storage unit 606, disk drive unit 609 or other storage medium units coupled to the system.

The drives and their associated computer-readable media provide nonvolatile storage of computer-readable instructions, data structures, program modules and other data for the computer 600. It should be appreciated by those skilled in the art that any type of computer-readable media which can store data that is accessible by a computer, such as magnetic cassettes, flash memory cards, digital video disks, Bernoulli cartridges, random access memories (RAMs), read only memories (ROMs), and the like, may be used in the exemplary operating environment.

The computer 600 may operate in a networked environment using logical connections to one or more remote computers. These logical connections are achieved by a communication device 611 (e.g., such as a network adapter or modern) coupled to or incorporated as a part of the computer 600. Of course the described system is not limited to a particular type of communications device. Exemplary logical connections include without limitation a local-area network (LAN) and a wide-area network (WAN). Such networking environments are commonplace in office networks, enterprise-wide computer networks, intranets and the Internal, which are all exemplary types of networks.

In addition to the specific implementations explicitly set forth herein, other aspects and implementations will be apparent to those skilled in the art from consideration of the specification disclosed herein. It is intended that the considered as examples only, with

1. A method comprising:
registering a plurality of system nodes with a data node communicatively coupled to a control node;
identifying at the control node a number of clients authorized to access each of the system nodes;
receiving at the control node a request from an authorized client to access and control at least one of the system nodes; and
establishing via the control node and data node a secure authenticated connection between the authorized client and the system node.

2. The method of claim 1 wherein the system nodes are always connected to the data node.

3. The method of claim 1 wherein the secure authenticated connection is via an SSH tunnel.

4. The method of claim 1 further comprising forwarding requests from the client to a designated port on the system node for controlling the system node from the client.

5. The method of claim 1 further comprising maintaining an online status of the system node at the control node.

6. The method of claim 1 further comprising providing a listing of at least one system node the client is authorized to access to the client in response to receiving the request from the client to access the system node.

7. A computer program product encoding computer programs for executing a computer process on a control node communicatively coupled to a data node, the computer process comprising:
registering a plurality of system nodes with the data node;
identifying at the control node a number of clients authorized to access the system nodes;
receiving at the control node a request from an authorized client to access and control at least one of the system nodes; and
establishing via the control node and data node a secure authenticated connection between the authorized client and the system node.

8. The computer program product of claim 7 wherein the computer process further comprises establishing the secure authenticated connection as an SSH tunnel via the control node and the data node.

9. The computer program product of claim 7 wherein the computer process further comprises forwarding requests from the client to a designated port on the system node.

10. The computer program product of claim 7 wherein the computer process further comprises maintaining an online status of the system node at the control node.

11. The computer program product of claim 7 wherein the computer process further comprises providing a listing of at least one system node the client is authorized to access to the client in response to receiving the request from the client to access the system node.

12. A service provider system for establishing a secure authenticated network connection between remote clients and system nodes for controlling building automation systems, comprising:
a data node securely connecting to a plurality system nodes, the data node registering each of the securely connected system nodes; and
a control node communicatively coupled to the data node, the control node authenticating a remote client to access and control at least one of the system nodes registered with the data node and then establishing a secure authenticated connection between the remote client and the system node.

13. The system of claim 12 wherein the control node is a web server.

14. The system of claim 12 wherein the secure authenticated connection is via an SSH tunnel established through the control node and data node.

15. The system of claim 12 wherein the control node forwards requests from the remote client through the control node and data node to a designated port on the system node.

16. The system of claim 12 wherein the control node maintains a data store including system nodes and clients authorized to access the system nodes.

17. The system of claim 12 wherein the data node maintains a data store including system node registrations.

18. The system of claim 12 wherein the data node maintains at data store including status of the system nodes.

19. The system of claim 12 wherein the remote client is provided access to control predetermined features of the building automation system via the secure authenticated connection.

20. The system of claim 12 wherein the remote client is provided restricted access to the building automation system via the secure authenticated connection.
